(19) United States
(12) Patent Application Publication
(10) Pub. No.: US 2012/0092486 A1
(43) Pub. Date: Apr. 19, 2012

(54) SYSTEM AND METHOD FOR CONTROLLING A MULTI-MACHINE CARAVAN

(75) Inventors: Michael S. McDaniel, Peoria, IL (US); Jeffrey E. Jensen, Dunlap, IL (US)

(73) Assignee: Caterpillar Inc., Peoria, IL (US)

(21) Appl. No.: 13/334,867

(22) Filed: Dec. 22, 2011

Related U.S. Application Data
(63) Continuation of application No. 12/073,176, filed on Feb. 29, 2008.

(51) Int. Cl. H04N 7/18

(52) U.S. Cl. 348/118; 348/E07.085

(57) ABSTRACT

The present disclosure is directed to a system for controlling a plurality of machines. The system includes a camera disposed on a second machine and configured to record at least one image of a first machine. A controller is configured to be in communication with the first machine and the second machine. The controller is configured to track information associated with the recorded image of the first machine. The controller is also configured to determine a direction of movement of the second machine based on an analysis of the tracked information.

### CROSS REFERENCE TO RELATED APPLICATION

This application is related to U.S. patent application Ser. No. 12/073,176, filed with the U.S. Patent and Trademark. Office on Feb. 29, 2011, the entirety of which is incorporated herein by reference.

### TECHNICAL FIELD

The present disclosure relates generally to a system and method for controlling a multi-machine caravan.

### BACKGROUND

Mining and large scale excavating operations may require fleets of machines to transport excavated material, such as ore or overburden, from an area of excavation to a destination. For such an operation to be productive and profitable, the fleet of machines must be efficiently operated. One way to increase the efficiency of a fleet of machines is to reduce the number of operators required to operate the fleet by, for example, using autonomous or semi-autonomous machines.

A method of operating a semi-autonomous machine is disclosed in U.S. Pat. No. 7,277,754 (the '754 patent), issued to Weiss et al. The '754 patent discloses a method of operating a manned harvester and an unmanned transport machine. The unmanned transport machine contains a control unit, connected to a receiving unit that is configured to receive position data from the harvester. The control unit operates the transport machine based on the position data from the harvester and, for example, drives the transport machine parallel to the harvester.

Although the method of operating a semi-autonomous machine of the '754 patent may increase the efficiency of a fleet by reducing the number of required operators, the method may not be appropriate for operating a multi-machine caravan in an excavating operation. In particular, the method may be incapable of increasing the following machine's engine power when, for example, traversing a grade. Furthermore, the method of communicating position data from a lead machine to the following machine may be impractical for use with multiple unmanned machines following a manned machine in series, for example, with a multi-machine caravan traveling along a haul road.

It is therefore desirable to provide, among other things, an improved system and method for controlling a multi-machine caravan.

### SUMMARY

In accordance with one embodiment, the present disclosure is directed to a system for controlling a plurality of machines. The system includes a camera disposed on a second machine and configured to record at least one image of a first machine. A controller is configured to be in communication with the first machine and the second machine. The controller is configured to track information associated with the recorded image of the first machine. The controller is also configured to determine a direction of movement of the second machine based on an analysis of the tracked information.

In another embodiment, the present disclosure is directed to a method of controlling a plurality of machines. The method includes recording at least one image of a first machine. The method further includes tracking information associated with the recorded image of the first machine. The method also includes determining direction of movement of a second machine based on an analysis of the tracked information.

### BRIEF DESCRIPTION OF THE DRAWINGS

FIG. 1 is a diagrammatic illustration of an exemplary disclosed worksite.

FIG. 2 is a diagrammatic illustration of a plurality of machines operable within the worksite of FIG. 1.

FIG. 3 illustrates in flowchart form a method for controlling a plurality of machines.

### DETAILED DESCRIPTION

Reference will now be made in detail to exemplary embodiments, which are illustrated in the accompanying drawings. Wherever possible, the same reference numbers will be used throughout the drawings to refer to the same or like parts.

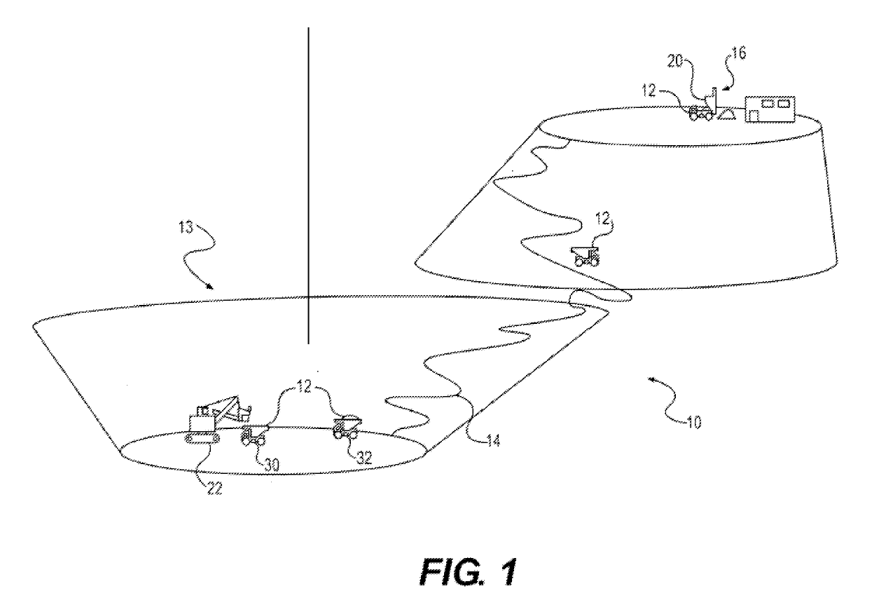

FIG. 1 illustrates an exemplary worksite 10 with a fleet of machines 12 performing a predetermined task. Worksite 10 may include, for example, a mine site, a landfill, a quarry, a construction site, a roadwork site, or any other type of worksite. The predetermined task may be associated with any work activity appropriate at worksite 10, and may include machines 12 generally traversing the worksite 10. For example, the fleet of machines 12 may travel from an area of excavation of an open pit mine 13 along a haul route 14 to a processing region 16. In the open pit mine 13, another machine 22 may operate to excavate material, e.g., ore or overburden, and may load the excavated material into the machines 12. The machines 12 may carry a payload, e.g., the excavated material, when traveling from the open pit mine 13 to the processing region 16. In an exemplary haul cycle, a payload may be loaded onto the machine 12, the machine 12 may travel along haul route 14 from the mine 13 to the processing region 16, the payload may be unloaded from the machine 12, and the machine 12 may travel along haul route 14 back to the mine 13 from the processing region 16.

The machine 12 may be an off-road machine. The disclosed embodiment may be applicable to other types of machines such as, for example, other earth moving machinery capable of carrying a payload. The disclosed embodiment may also be applicable to a mobile machine that performs some type of operation associated with an industry such as mining, construction, farming, transportation, or any other industry known in the art. For example, the machine may be a commercial vehicle, such as a truck, crane, earth moving machine, mining machine, material handling equipment, farming equipment, marine vessel, aircraft, an excavator, a dozer, a loader, a backhoe, a motor grader, a dump truck, or any type of machine that operates in a work environment such as a construction site, mine site, power plant, etc.

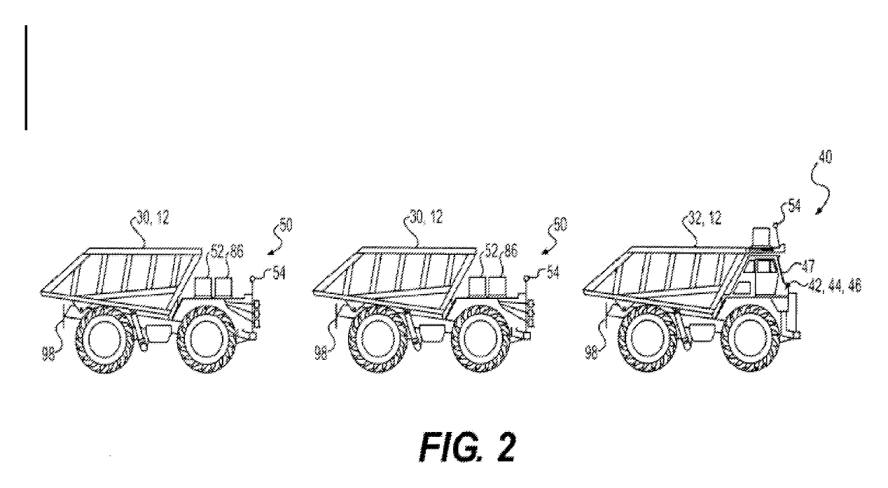

FIG. 2 illustrates a diagrammatic representation of a plurality of machines operable within the worksite. In order to reduce the number of operators required for operation of the fleet of machines 12, it may be desirable for one or more unmanned machines 30 to follow a lead manned machine 32 in series to form a multi-machine caravan. A control system 40 may be configured to affect control of the multi-machine caravan for this purpose. The control system 40 may include a camera system 86, and a controller 54. The control system 40 may also include a first set of operator input devices 42, and a second set of operator input devices 44 (i.e., an auxiliary operator input system), each located in a cab 47 of the lead manned machine 32. The control system 40 may also include an actuator system 52 mounted onboard each unmanned machine 30. Although two unmanned machines 30 are shown in FIG. 2, it is contemplated that the multi-machine caravan may include a single unmanned machine 30 or more than two unmanned machines 30.

The camera system 86 may be mounted on unmanned machine 30 to record and store images of the first machine 32. These images may be still photographs or moving images such as videos or movies of the manned machine 32. The camera system 86 may be operably connected to the controller 54. The camera system 86 may use one or more electronic image sensors (e.g., a charge coupled device (CCD) or a CMOS sensor) to capture images that can be transferred or stored in a memory card or other storage inside the camera for later playback or processing. The camera 86 may be positioned such that it is aligned to a target 98 located on the manned machine 32. The camera 86 can be adapted or focused to record changes in direction, distance, and orientation of the target 98 in order to determine changes in direction, distance, orientation, and angle of the manned machine 32. For example, when the control system 40 is operating in a first mode of operation, the controller 54 may continuously compute distances between the unmanned machine 30 and the target 98 based on images recorded and stored by the camera 86 of the manned machine 32.

The controller 54 can then determine differences between the recorded images by the camera 86 of the manned machine 32 and corresponding prior stored images of the manned machine 32, in order to determine whether the target 98 of the manned machine 32 is changing direction to the left or right, increasing or decreasing speed, or changing in elevation e.g., ascending or descending a grade. Such prior stored images are stored as three-dimensional (3-D) computer images or models, a table of machine dimensions, etc. In alternative embodiments, the recorded image and the stored images can be configured as any of two-dimensional or three-dimensional images. Further, the controller 54 may compare current tracked information of the manned machine 32 such as a determined distance between the unmanned machine 30 and the target 98 of the manned machine 32, to information previously stored in one of its maps. Based on the compare, the controller 54 can determine that because the distance has increased or decreased compared to a previous or desired distance, the speed of the target 98 has changed. With this information, the controller 54 can communicate to the actuator system 52 that a change in direction, acceleration, or braking is necessary to follow the target 98 at a predetermined distance that may be stored in one of its maps.

By continuously comparing images recorded of the target 98 and of manned machine 32 with stored images of the target 98 and of the manned machine 32 that are continuously updated, the controller 54 can make a determination as to whether the manned machine 32 is ascending, descending, or traveling straight/flat on a grade. The controller 54 can communicate results of such determinations to the actuator system 52. This may enable the actuator system 52 to correspondingly adjust the engine torque and/or speed of travel of the unmanned machine 30 when the unmanned machine is ascending a grade. The controller 54 can also communicate with the actuator system 52 when the controller 54 determines that the target 98 of the manned machine is descending down a grade. The controller 54 can also enable the actuator system 52 to, for example, prepare the unmanned machine 30 for down-shifting or brake engagement. Similarly, the controller 54 may also cause a left-hand turn or a right-hand turn of the unmanned machine 30 via the actuator system 52 based on a continuous tracking of information associated with the recording of images of the target 98, and then comparing current tracked information to prior stored tracked information images to determine such changes in directions, orientation and angle of the target. The controller 54 can then communicate with the actuator system 52 located on a corresponding unmanned machine 30 to cause a corresponding change in direction (e.g., left-hand turn, right-hand turn) of the unmanned machine 30.

Also, the controller 54 may select either a first mode of operation or a second mode of operation. In the first mode of operation, the second machine follows the first machine based on a compare of the current tracked information associated with the recorded image of the first machine 32 with prior tracked information associated with the recorded image of the first machine 32 that is stored in memory. Hence, in the first mode of operation, the unmanned machines 30 may follow a lead machine 32 without direct control from an operator (i.e. independent of input from the manned machine 32). Thus, the first mode of operation may be useful, for example, when the machines 12 are traveling along the haul route 14. When the second mode of operation is selected, the second machine 30 moves based on signals received from the first set of operator input devices Thus, an operator may remotely control the unmanned machines 30 from the manned machine 32. The second mode can be useful, for example, when the machines 12 are operating at the open pit mine 13 or the processing region 16.

Therefore, the controller 54 serves to facilitate communication between the first machine 32 (manned) and the second machine 30 (unmanned). The controller 54 may communicate the selection of the first mode of operation or a second mode of operation from the manned machine 32 to the unmanned machines 30. In the first mode of operation, the unmanned machines 30 may communicate position and speed to the manned machine 32. In the second mode of operation, control signals for braking, steering, and acceleration may be communicated from the auxiliary operator input system 44 to the actuator systems 52 of unmanned machines 30. The controller 54 can also be configured with a wireless communication system that can include a satellite data link, cellular data link, radio frequency data link, or other form of wireless data link. As such, the controller 54 may include communication elements, mounted on each of unmanned machines 30 and manned machine 32, to communicate operating parameters between the machines. For example, the controller 54 can be configured to track information associated with a recorded image of first machine 32. The controller 54 can then perform an analysis of the tracked information to determine a direction of movement of the second machine 30. Such analysis can include a compare of the current tracked information associated with the recorded image of the first machine 32 with prior tracked information associated with the recorded image of the first machine 32 that is stored in memory. The controller can be configured to continuously store and update in memory the tracked information of the recorded image of the first machine 32. Further, the controller 54 may include one or more maps storing, for example, 3D pictures of the manned machine 32, ranges of desired distances, orientation and angle from the unmanned machine 30 to the manned machine.

It is noted that the controller 54 may be configured with, or as a number of conventional devices such as a microprocessor, a timer, input/output devices, and a memory device. Numerous commercially available microprocessors can be configured to perform the functions of controller 54. It should be appreciated that the controller 54 could readily embody a computer system capable of controlling numerous other functions. Various other circuits may be associated with the controller 54, including signal-conditioning circuitry, communication circuitry, and other appropriate circuitry as known in the art.

The first set of operator input devices 42 can be disposed on the first machine 32. The movement of the manned machine 32 may be at least partially determined by the first set of operator input system 42, which can be located in the cab 47 of the manned machine 32. The first set of operator input system 42 may include an acceleration control, a braking control, and a direction control. The acceleration control of the manned machine 32 may include, for example, an acceleration pedal and/or a deceleration pedal connected to control the power source and/or an associated transmission to accelerate or decelerate the manned machine 32. The braking control of manned machine 32 may include, for example, a brake pedal connected to a braking element to slow or stop manned machine 32. The direction control of the manned machine 32 may include, for example, a steering wheel, a joystick, or any other direction control known in the art configured to change the direction of the manned machine 32. It is contemplated that manned machine 32 may include any number of other components and features such as, for example, a traction device, an implement, or any other component or feature known in the art.

The second set of operator input devices 44 can serve as an auxiliary operator input system that may be operably connected to the controller 54. The controller 54 may communicate control signals to the actuator systems 52 (referring to FIG. 2) located onboard the unmanned machines 30. The auxiliary operator input system 44 and/or the first set of operator input devices 42 may contain a toggle switch for selecting the first or second mode of operation. In addition, the auxiliary operator input system 44 may contain control inputs for acceleration, braking, direction, and implement control similar to those included in the first set of operator input devices 42. When the control system 40 is in the second mode, the outputs of the auxiliary operator input system 44 may be communicated via the controller 54 as a control signal to the actuator systems 52, of unmanned machines 30 to affect control thereof. The actuator systems 52 may actuate brake, steering, acceleration, and work implement systems based on control signals received from the auxiliary operator input system 44. In an embodiment where more than one unmanned machine 30 is used, the auxiliary operator input system 44 may include an additional control (i.e. a switch) for selecting one or more unmanned machines 30 to remotely control in the second mode. For example, based on a control signal from auxiliary operator input system 44, one unmanned machine 30 may remain stationary while another unmanned machine 30 is controlled to move about the worksite 10.

The actuator system 52 may be any control system capable of receiving an electronic signal and actuating the steering, brake, acceleration, and work implement control systems of the unmanned machine 30. For example, the actuator system 52 may be a drive-by-wire system, or another system known in the art. The actuator system 52 may additionally receive various input signals representative of the unmanned machine 30 system operating parameters including an engine speed signal from an engine speed sensor, a transmission input speed signal from a transmission input speed sensor, and a transmission output speed signal from a transmission output speed sensor. The sensors may be conventional electrical transducers, such as, for example, a magnetic speed pickup type transducer. These signals may be communicated to the manned machine 32 via the communications system 54 for display on display 46.

### INDUSTRIAL APPLICABILITY

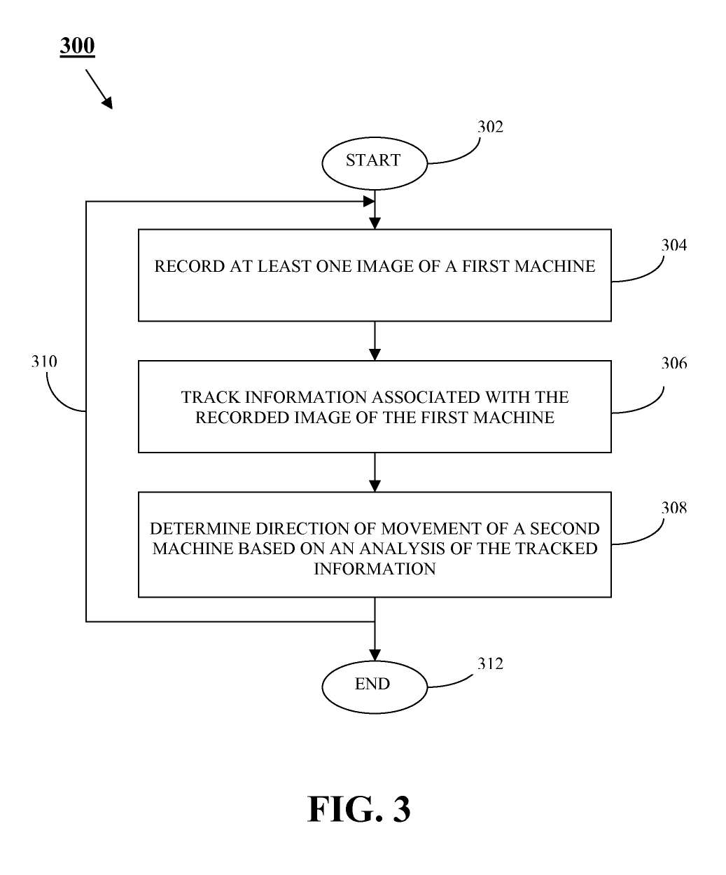

The disclosed system 40 can be applicable to multi-machine caravan that requires an efficient method and system to operate machines without the use of human operators assigned to each respective machine. The operation of the system 40 will now be explained in connection with the flowchart of FIG. 3.

FIG. 3 illustrates in flow-chart form a method 300 for controlling a plurality of machines according to one embodiment. The method starts in operation 302. In operation 304, at least one a camera 86 may record at least one image of a first machine 32 of the plurality of machines. The controller 54 can also track information associated with the recorded image of the first machine 32, in operation 306. Based on an analysis of the tracked information, the controller can determine a direction of movement of a second machine 30, in operation 308. In operation 310, the method 300 can repeat until the plurality of machines 30, 32 reach their destination (e.g., the processing region 16) and/or complete their required tasks. The method ends in operation 312.

The disclosed method 300 of controlling a multi-machine caravan may be applicable to any fleet of machines. The disclosed method of controlling a multi-machine caravan may increase the efficiency of the machine operation by reducing the number of operators required to operate a fleet of machines. Exemplary embodiments of the method of controlling a fleet of machines are described below.

In FIG. 1, machines 12 may traverse worksite 10 to perform any operation associated with operation of worksite 10. In FIG. 2, in order to reduce the number of drivers required to operate the machines 12, one or more unmanned machines 30 may form a caravan to follow a manned machine 32. Thus, an operator in manned machine 32 may use auxiliary operator input 44 to place control system 40 in the first mode of operation and the controller 54 may communicate this mode of operation to the actuator systems 52 of unmanned machines 30.

When the manned machine 32 and the unmanned machines 30 reach the open pit mine 13 or the processing region 16, it may be desirable to place the control system 40 in the second mode of operation to initiate remote control of the unmanned machines 30. In the second mode, the operator may stop the manned machine 32 and control one or more of the unmanned machines 30 to move about the worksite 10 or use a work implement, for example to dump a load of ore or overburden. Thus, the operator may use the auxiliary operator input system 44 to place the control system 40 in the second mode and select one or more unmanned machines 30 to control remotely. The selected mode may be communicated to the selected unmanned machines 30 so that the actuator 52 actuates the acceleration, direction, braking, and implement control systems based on the control signal from the auxiliary operator input system 44.

It is further considered that in the second mode of control system 40 the auxiliary operator input system 44 may be used to control other unmanned machines at the worksite 10, for example, machine 22 (referring to FIG. 1). In this embodiment, the machine 22 may also include a communication element and a drive-by-wire system (not shown) to facilitate remote control by the auxiliary operator input system 44 in a manner similar to that discussed above.

The disclosed system may be an inexpensive, effective solution for reducing the number of operators required to operate a machine caravan. The control system may enable a single operator to navigate a fleet of machines in series along a haul route and remotely operate the fleet and/or other machines to load and unload materials. In addition, because no operator is required in the unmanned machine, the cab may be eliminated, substantially decreasing manufacturing cost of the machine

While this disclosure includes particular examples, it is to be understood that the disclosure is not so limited. Numerous modifications, changes, variations, substitutions and equivalents will occur to those skilled in the art without departing from the spirit and scope of the present disclosure upon a study of the drawings, the specification and the following claims.

What is claimed is:

1. A system for controlling a plurality of machines, comprising:
a camera disposed on a second machine and configured to record at least one image of a first machine;
a controller in communication with the first machine and the second machine, the controller configured to:
track information associated with the recorded image of the first machine;
determine a direction of movement of the second machine based on an analysis of the tracked information.

2. The control system in claim 1, wherein the analysis includes a compare of current tracked information and prior tracked information associated with the first machine.

3. The control system of claim 1, wherein the controller is further configured to selectively communicate:
a first mode of operation in which the second machine follows the first machine based on the analysis of the tracked information; and
a second mode of operation in which the second machine moves based on a signal from the first set of operator input devices.

4. The control system of claim 1, further comprising:
a first set of operator input devices disposed on the first machine; and
a second set of operator input devices located on the first machine for controlling the movement of the first machine.

5. The control system of claim 4, wherein the first set of operator input devices includes controls for actuating at least one of a steering, braking, acceleration, or implement control system of the second machine.

6. The control system in claim 2, wherein the controller continuously updates memory with the current tracked information of the first machine.

7. The control system in claim 1, wherein the tracked information relates to distance, angle, orientation, and direction of movement of the first machine.

8. The control system of claim 1, further comprising:
an actuator system located on the second machine and configured to actuate at least one of a brake control system, an acceleration control system, and a steering control system of the second machine

9. The control system in claim 1, wherein the recorded image of the first machine is configured as a 2-dimensional image.

10. The control system in claim 9, wherein the recorded image of the first machine is stored as a 3-dimensional model in memory.

11. A method of controlling a plurality of machines, comprising:
recording at least one image of a first machine;
tracking information associated with the recorded image of the first machine; and
determining a direction of movement of a second machine based on an analysis of the tracked information.

12. The method of claim 11, wherein the analysis includes a compare of current tracked information and prior tracked information associated with the first machine.

13. The method of claim 11, further comprising:
selecting a first mode of operation or a second mode of operation;
controlling the second machine based on the analysis of the tracked information associated with the first machine when in the first mode of operation; and
controlling the second machine based on a signal received from the first machine when in the second mode of operation.

14. The method of claim 13, wherein the controlling of the second machine based on the analysis of the tracked information includes at least one of:
increasing and/or decreasing an engine torque and/or speed based on results of the analysis;
actuating a steering control system based on results of the analysis; and
actuating a braking control system based on results of the analysis.

15. The method of claim 11, wherein the tracked information relates to distance, angle, orientation, and direction of movement of the first machine.

16. The method of claim 11, wherein the tracked information relates to distance, angle, orientation, and direction of movement of the first machine.

17. The method of claim 11, further comprising:
actuating at least one of a brake control system, an acceleration control system, and a steering control system of the second machine based on the determining of the direction of movement of the second machine.

18. The method of claim 12, further comprising:
continuously updating a memory with the current tracked information of the first machine.

19. The method of claim 11, wherein the recorded image of the first machine is configured as a 2-dimensional image.

20. The method of claim 11, wherein the recorded image of the first machine is stored as a 3-dimensional model in memory.
